(19) United States
(12) Patent Application Publication
(10) Pub. No.: US 2010/0109993 A1
(43) Pub. Date: May 6, 2010

(54) LIQUID CRYSTAL DISPLAY AND METHOD OF MANUFACTURING THE SAME

(76) Inventor: Jong-Woong Chang, Cheonan-si (KR)

Correspondence Address: Haynes and Boone, LLP;IP Section, 2323 Victory Avenue, SUITE 700, Dallas, TX, 75219, US

(21) Appl. No.: 12/420,795

(22) Filed: Apr. 8, 2009

(30) Foreign Application Priority Data
Oct. 30, 2008 (KR) 10-2008-0106967

(51) Int. Cl. G09G 3/36; B05D 5/12

(52) U.S. Cl. 345/92; 427/68

(57) ABSTRACT

A liquid crystal display according to an embodiment includes: a substrate; a plurality of signal lines formed on the substrate; a thin film transistor connected to the signal lines; a pixel electrode connected to the thin film transistor; an insulating layer covering the signal lines and having a first contact hole exposing a first end of the signal lines; and a first bridge connected to the signal lines through the first contact hole. The first bridge is disposed on the edge of the substrate, and the cross-section of the first bridge is exposed in the side direction of the substrate. A method for manufacturing a display device according to an embodiment includes forming a signal line on a first substrate; forming a passivation layer on the signal line, the passivation layer including a contact hole exposing a portion of the signal line; forming a bridge on the contact hole; and coating a sealant on the contact hole.

### CROSS-REFERENCE TO RELATED APPLICATIONS

This application claims priority to and the benefit of Korean Patent Application No. 10-2008-0106967 filed in the Korean Intellectual Property Office on Oct. 30, 2008, the entire contents of which are incorporated herein by reference.

### BACKGROUND

1. Technical Field

The present invention relates generally to liquid crystal displays and, more particularly, to a liquid crystal display having high reliability and a method for manufacturing the liquid crystal display.

2. Related Art

Recently, the necessity for a flat panel display having excellent characteristics such as thinness, light weight, and low power consumption has been realized as the information industry has developed. Among flat panel displays, liquid crystal displays having excellent resolution, color display, and display quality are being actively deployed to laptops and as desktop monitors.

Generally, in a liquid crystal display, two substrates provided with respective electrodes are disposed parallel to each other, and a liquid crystal material is injected between the two substrates. A voltage is applied to the two electrodes such that an electric field to drive the liquid crystal molecules is generated to display images by changing transmittance of the light according to the intensity of the voltage.

The liquid crystal display generally includes a liquid crystal panel injected with the liquid crystal between two substrates, a backlight disposed under the liquid crystal panel and used as a light source, and a driver disposed on the edge of the liquid crystal panel and driving the liquid crystal panel. The driver typically includes a driving circuit for applying signals to the wiring lines of the liquid crystal panel, and is classified as a chip on glass (COG), a tape carrier package (TCP), or a chip on film (COF) style according to the method for mounting the driving circuit to the liquid crystal panel.

There is a need, however, to increase the reliability at a portion for connecting the panel and the driving circuit such that the display quality of the panel does not deteriorate, and the number of faulty panels is decreased.

The above information disclosed in this Background section is only for enhancement of understanding of the background of embodiments of the invention and therefore it may contain information that does not form the prior art that is already known in this country to a person of ordinary skill in the art.

### SUMMARY

Accordingly, embodiments of the present invention provide a liquid crystal display and a method for manufacturing the liquid crystal display to prevent difficulties with corrosion and static electricity.

A display device according to an embodiment of the present invention includes: a substrate; a plurality of signal lines formed on the substrate; a thin film transistor connected to the signal lines; a pixel electrode connected to the thin film transistor; an insulating layer covering the signal lines and having a first contact hole exposing a first end of the signal lines; and a first bridge connected to the signal lines through the first contact hole, wherein the first bridge is disposed on an edge of the substrate, and a cross-section of the first bridge is exposed in a side direction of the substrate.

The first bridge and the pixel electrode may be formed with the same material. The first bridge and the pixel electrode may be made of a transparent conductive layer. Each of the signal lines may include a pad portion of which the width is increased near the first contact hole. The display device may further include a static electricity prevention member formed on the circumference of the pad portion to prevent static electricity. The signal lines may include a gate line formed on the substrate and transmitting a gate signal. The signal lines may include a data line formed on the substrate and transmitting a data signal. The display device may further include a plurality of signal line extension portions formed on the substrate and separated from the signal lines; a second contact hole exposing a second end of the signal lines and a third contact hole exposing the signal line extension portions, in the insulating layer; and a second bridge connecting the signal lines and the signal line extension portions through the second contact hole and the third contact hole. The signal line extension portions may include a fan-out portion that is curved in a direction in which a distance between the signal line extension portions becomes close.

A display device according to another embodiment of the present invention includes: a substrate; a plurality of signal line formed on the substrate; a plurality of first signal line extension portions formed on the substrate and separated from the signal lines, the first signal line extension portions being disposed on an edge of the substrate; a thin film transistor connected to the signal lines; a pixel electrode connected to the thin film transistor; an insulating layer covering the signal lines and the signal line extension portions, and including a first contact hole exposing a first end of the signal lines and a second contact hole exposing the first signal line extension portions; and a first bridge connecting the signal lines and the signal line extension portions through the first contact hole and the second contact hole, wherein a cross-section of the first signal line extension portions is exposed in a side direction of a cutting portion of the substrate.

The first bridge and the pixel electrode may be made of the same material. The first bridge and the pixel electrode may be made of a transparent conductive layer. The signal lines may include a pad portion of which the width is increased near the first contact hole. The signal lines may include a gate line formed on the substrate and transmitting a gate signal. The signal lines may include a data line formed on the substrate and transmitting a data signal. The display device may further include a plurality of second signal line extension portions formed on the substrate and separated from the signal lines; a third contact hole exposing a second end of the signal lines and a fourth contact hole exposing the second signal line extension portions in the insulating layer; and a second bridge connecting the signal lines and the second signal line extension portions through the third contact hole and the fourth contact hole. The second signal line extension portions may include a fan-out portion that is curved in a direction in which an interval between the second signal line extension portions gradually becomes narrower.

A display device according to another embodiment of the present invention includes: a substrate; a plurality of signal lines formed on the substrate; a plurality of first signal line extension portions formed on the substrate and separated from the signal line, the first signal line extension portions being disposed on an edge of the substrate; a thin film transistor connected to the signal lines; a pixel electrode connected to the thin film transistor; an insulating layer covering the signal lines and the signal line extension portions, and including a first contact hole exposing a first end of the signal lines and a second contact hole exposing the first signal line extension portions; and a first bridge connecting the signal lines and the signal line extension portions through the first contact hole and the second contact hole, wherein a cross-section of the first signal line extension portions is exposed in a side direction of a cut surface of the substrate, the bridge is formed in a light blocking region formed on a circumference of the pixel electrode, and a sealant is formed on the first contact hole and the second contact hole.

The first bridge and the pixel electrode may be made of the same material. The first bridge and the pixel electrode may be made of a transparent conductive layer. The signal lines may include a pad portion of which a width is increased near the first contact hole. The display device may further include a static electricity prevention member formed on a circumference of the pad portion to prevent static electricity. The substrate may further include a driving circuit applying a signal to the pixel electrode. The driving circuit may be mounted on the substrate. The display device may further include a plurality of second signal line extension portions formed on the substrate and separated from the signal lines; a third contact hole exposing a second end of the signal lines and a fourth contact hole exposing the second signal line extension portions in the insulating layer; and a second bridge connecting the signal lines and the second signal line extension portions through the third contact hole and the fourth contact hole. The second signal line extension portions may include a fan-out portion that is curved in the direction in which a distance between the second signal line extension portions becomes short.

A display device according to another embodiment of the present invention includes: a substrate; a driving circuit electrically connected to the substrate; a fan-out portion applying a signal to a pixel area from the driving circuit; a light blocking portion formed between the fan-out portion and the pixel area; a signal line connected to the fan-out portion; a transistor connected to the signal line; a pixel electrode connected to the transistor; and a bridge overlapping the light blocking portion and connecting the fan-out portion and the signal line.

The driving circuit may be mounted on the substrate. A sealant may be formed on the bridge. The bridge may be formed with the same material as the pixel electrode. The display device may further include a passivation layer having a contact hole exposing the signal line and the fan-out portion under the bridge. The display device may further include a signal line extension portion separated from the signal line on the light blocking portion of an edge of the substrate on an opposite side of the fan-out portion, and a second bridge connecting the signal line and the signal line extension. The display device may further include a passivation layer having a contact hole exposing the signal line and the fan-out portion under the bridge. A sealant may be formed on the contact hole.

A method for manufacturing a display device according to another embodiment of the present invention includes: forming a signal line on a first substrate; forming a passivation layer on the signal line, the passivation layer including a contact hole exposing a portion of the signal line; forming a bridge on the contact hole; and coating a sealant on the contact hole.

The bridge may be formed of a transparent conductive layer (e.g., made of indium tin oxide (ITO) or indium zinc oxide (IZO)). The method may further include, before coating the sealant on the contact hole, forming a second substrate corresponding to the first substrate, wherein the second substrate has a light blocking portion formed in a region corresponding to the bridge.

A method for manufacturing a display device according to another embodiment of the present invention includes: forming a signal line on a first substrate; forming a signal line extension separated from the signal line; forming a passivation layer on the signal line, the passivation layer exposing a portion of the signal line and having a contact hole exposing the portion of the signal line extension; forming a bridge on the contact hole, the bridge connecting the signal line and the signal line extension; and coating a sealant on the contact hole.

The bridge may be formed of a transparent conductive layer. The method may further include, before coating the sealant on the contact hole, forming a second substrate corresponding to the first substrate, wherein the second substrate has a light blocking portion formed on a region corresponding to the bridge.

According to an embodiment of the present invention, a panel for preventing corrosion may be formed, thereby being economical.

### BRIEF DESCRIPTION OF THE DRAWINGS

FIG. 1 is a top plan view of a liquid crystal display according to an embodiment of the present invention.

FIG. 2 is a top plan, enlarged view of region A of FIG. 1 according to an embodiment of the present invention.

FIG. 3 is a cross-sectional view taken along the line III-III′ of FIG. 2 according to an embodiment of the present invention.

FIG. 4 is a top plan view taken along a cutting line of FIG. 2 of a liquid crystal display according to an embodiment of the present invention.

FIG. 5 is a top plan view of a liquid crystal display according to an embodiment of the present invention.

FIG. 6 is a top plan view of a liquid crystal display according to another embodiment of the present invention.

FIG. 7 is a top plan, enlarged view of region B FIG. 6 according to an embodiment of the present invention.

FIG. 8 is a cross-sectional view taken along the line VIII-VIII′ of FIG. 7 according to an embodiment of the present invention.

FIG. 9 is a top plan view showing a cutting of a liquid crystal display according to another embodiment of the present invention.

FIG. 10 is a top plan view showing a liquid crystal display according to another embodiment of the present invention.

FIG. 11 is a top plan view showing a cutting of a liquid crystal display according to another embodiment of the present invention.

FIG. 12 is a top plan view showing a liquid crystal display according to another embodiment of the present invention.

### DETAILED DESCRIPTION

Embodiments of the present invention will be described more fully hereinafter with reference to the accompanying drawings, in which embodiments of the invention are shown. As those skilled in the art would realize, the described embodiments may be modified in various different ways, all without departing from the spirit or scope of the present invention.

In the drawings, the thickness, for example, of layers, films, panels, and regions, may be exaggerated for clarity. It will be understood that when an element such as a layer, film, region, or substrate is referred to as being “on” another element, it can be directly on the other element or intervening elements may also be present. Like reference numerals designate like elements throughout the specification.

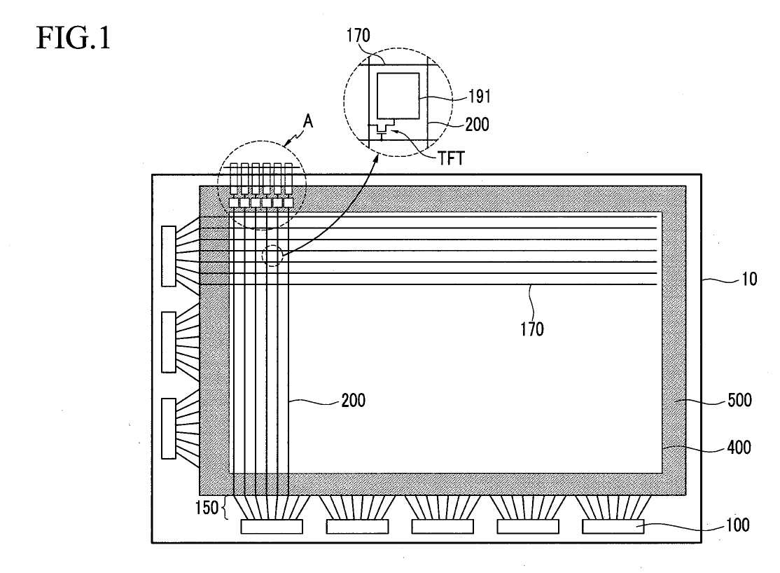

FIG. 1 is a top plan view of a liquid crystal display according to an embodiment of the present invention. Referring to FIG. 1, a liquid crystal display according to an embodiment of the present invention includes a lower panel 10, an upper panel (not shown), and a liquid crystal layer interposed therebetween. The lower panel 10 (also referred to as “substrate” or “thin film transistor array panel”) may include gate lines 170 and data lines 200 intersecting the gate lines 170 provided on the substrate 10. Images are displayed through a display area 400 formed with the gate lines 170 and the data lines 200.

The thin film transistor array panel 10 may be used as a circuit board for independently driving the pixels in the display device such as a liquid crystal display or an organic electro luminescence (EL) display. The thin film transistor array panel 10 includes signal lines or gate lines 170 transmitting scanning signals, image signal lines or data lines 200 for transmitting image signals, thin film transistors (indicated by “TFT” in FIG. 1) connected to the gate lines 170 and the data lines 200, pixel electrodes 191 connected to the thin film transistors TFT, a gate insulating layer (not shown) covering the gate lines 170 as an insulator, and a passivation layer (not shown) covering the thin film transistors TFT and the data lines 200.

The gate insulating layer may be made of silicon nitride (SiNx) or silicon oxide (SiOx). The passivation layer may be made of an inorganic insulator or an organic insulator, and may provide a flat surface. The organic insulator may have a dielectric constant less than 4.0 or photosensitivity. The gate insulating layer or the passivation layer may have an electrical insulation function.

The thin film transistor (TFT) includes a gate electrode that is a portion of a gate line 170, a semiconductor layer where a channel is formed, a source electrode that is a portion of a data line, a drain electrode, the gate insulating layer, and the passivation layer. The thin film transistor (TFT) is a switching element for transmitting or blocking image signals applied through the data line 200 to the pixel electrode 191 according to the scanning signal transmitted through the gate line 170.

The thin film transistor array panel 10 is connected to a driver integrated circuit (IC) to apply the driving signal to the gate line 170 and the data line 200. The driver IC is connected to the gate line or the data line through a pad, and pads are gathered into a narrow region for connection with the driver IC. The gate line 170 or the data line 200 disposed in the display area 400 may have a predetermined width according to the size of the pixel, and the predetermined width may be larger than an interval between the pads. Accordingly, there may be a region where the interval between the wiring lines becomes gradually wider between an out-lead bonding (OLB) pad portion 100 and the display area 400, and this region is referred to as a fan-out region 150. This is represented as the fan-out portion 150 in FIG. 1. A driver (not shown) connected to the OLB pad portion 100 on the lower portion of the substrate 10 shown in FIG. 1 is directly formed on the substrate 10. The structure in which the driver chip is directly formed on the substrate is referred to as the chip on glass (COG) structure and an array test portion A is formed opposite to the driver on the substrate 10. FIG. 1 also shows light blocking portion 500, described below.

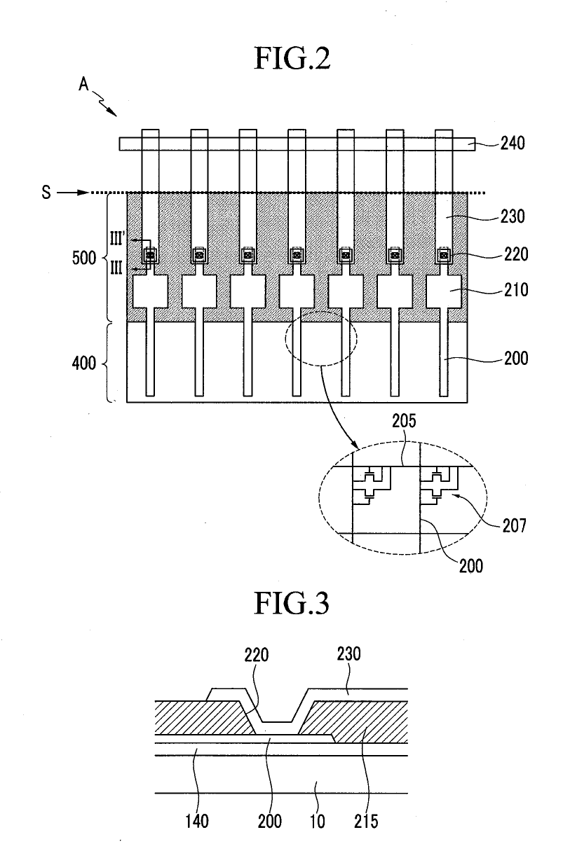

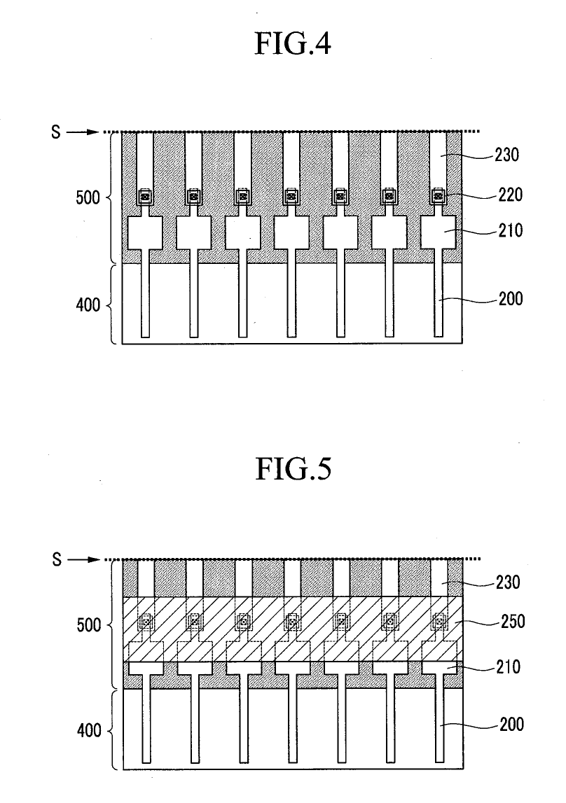

FIG. 2 is a top plan, enlarged view of region A of FIG. 1; FIG. 3 is a cross-sectional view taken along the line III-III′ of FIG. 2; and FIG. 4 is a top plan view taken along a cutting line S of FIG. 2 of a liquid crystal display according to one or more embodiments of the present invention. Referring to FIG. 2 through FIG. 4, an insulating layer 140 is formed on the substrate 10. The data line 200 is formed on the insulating layer 140, and a pad portion 210 is formed on the end portion of the data line 200. The pad portion 210 may have a wider width than the data line 200. A passivation layer 215 covering the data line 200 is formed. The passivation layer 215 has a contact hole 220 exposing the end portion of the data line 200.

A plurality of bridges 230 filling in the contact holes 220 and respectively connected to the plurality of data lines 200 are extended to the upper portion of the cutting line S. The bridges 230 may be made of a transparent conductive layer. For example, the bridge 230 may be made of indium tin oxide (ITO) or indium zinc oxide (IZO).

A shorting bar 240 connected to the plurality of bridges 230 is disposed on the upper portion of the cutting line S. The shorting bar 240 is used for an array test of whether a deterioration is generated for the signal line after the formation process of the thin film transistor. In the COG structure, it is difficult to execute an array test such that a loss of yield was generated, however the shorting bar 240 is installed on the edge of the substrate 10 on the opposite side to the driver such that the deterioration of the signal line may be detected according to an embodiment of the present invention. There may be a plurality of shorting bars 240. As an example, the shorting bars 240 may include a first shorting bar connected to the bridges of odd lines and a second shorting bar connected to the bridges of even lines among the plurality of bridges 230.

The light blocking portion 500 defines the pixel area, and is generally formed on an upper panel including a color filter. Next, the upper panel will be described.

The upper panel includes a light blocking portion 500 on an insulation substrate made of transparent glass or plastic, a color filter, an overcoat, and a common electrode, and is disposed to be opposite to the lower panel 10. The light blocking portion 500 prevents light leakage between pixel electrodes 191 and defines pixel areas corresponding to the pixel electrodes 191. The liquid crystal layer is formed between the upper panel and the lower panel 10. In the liquid crystal display, a voltage is applied between the pixel electrode 191 and the common electrode to generate an electric field in the liquid crystal layer such that the direction of liquid crystal molecules of the liquid crystal layer is determined and the polarization of incident light is controlled to display images.

If necessary, the color filter, the light blocking portion 500, and the common electrode may be selectively formed on the thin film transistor array panel 10.

After the array test, when a scribing process is executed, cutting is executed across the center of the bridge 230. As a result, the cross-section of the bridge 230 is exposed through a side direction of the panel 10.

As shown in FIG. 2, a wiring line 205 is formed on the circumference of the pad portion 210 to prevent the generation of static electricity flowing from the shorting bar 240, and a static electricity blocking member 207 may be installed. The static electricity blocking member 207 may include a diode or a thin film transistor. A plurality of static electricity blocking members 207 are formed for the data lines 200.

FIG. 5 is a top plan view of a liquid crystal display according to an embodiment of the present invention. Referring to FIG. 5, to prevent corrosion due to moisture, the contact hole 220 may be covered by a sealant 250, or overlap the liquid crystal layer (not shown).

In the above-described COG structure, the array test portion A is disposed on the pad portion region of the data lines, but is not limited thereto, and the array test portion A may be formed on a pad portion region of the gate lines. In FIG. 1, the array test portion A may be formed on the right side.

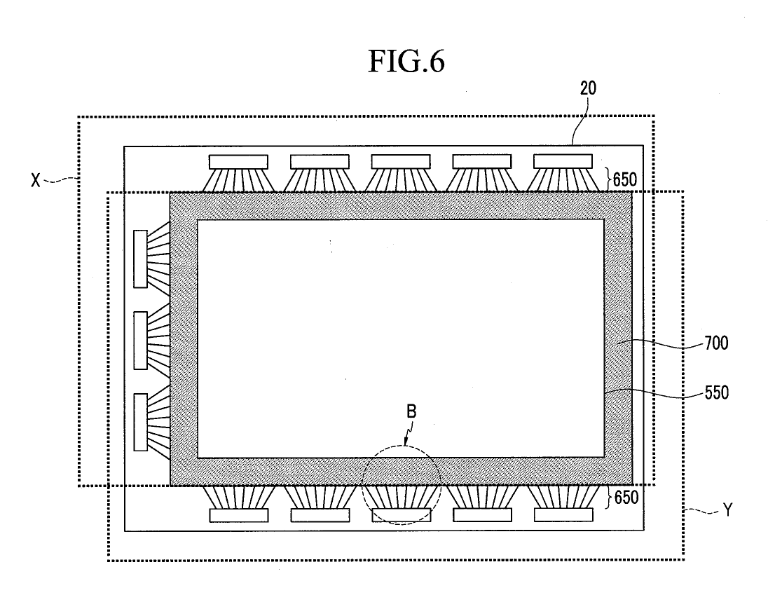

FIG. 6 is a top plan view of a liquid crystal display according to another embodiment of the present invention. Referring to FIG. 6, a top bent type panel in which a data driver is formed on the upper portion of the panel and a bottom bent type panel in which the data driver is formed on the lower portion of the panel may be formed by using one mask. If the scribing is executed according to the first cutting line X, the top bent type in which a data driver is formed on the upper portion of the panel may be made. On the other hand, if the scribing is executed according to the second cutting line Y, a bottom bent type in which the data driver is formed on the lower portion of the panel may be made.

Accordingly, a fan-out portion 650 is formed on both the upper and lower portions of the panel by using one mask before the scribing process, and the first cutting line X or the second cutting line Y is selected to thereby obtain the desired panel. The light blocking portion 700 defines the pixel area or display area 550, and is generally formed on an upper panel including a color filter. If the first cutting line X is used in the scribing process, the region B may be separated from the panel 20.

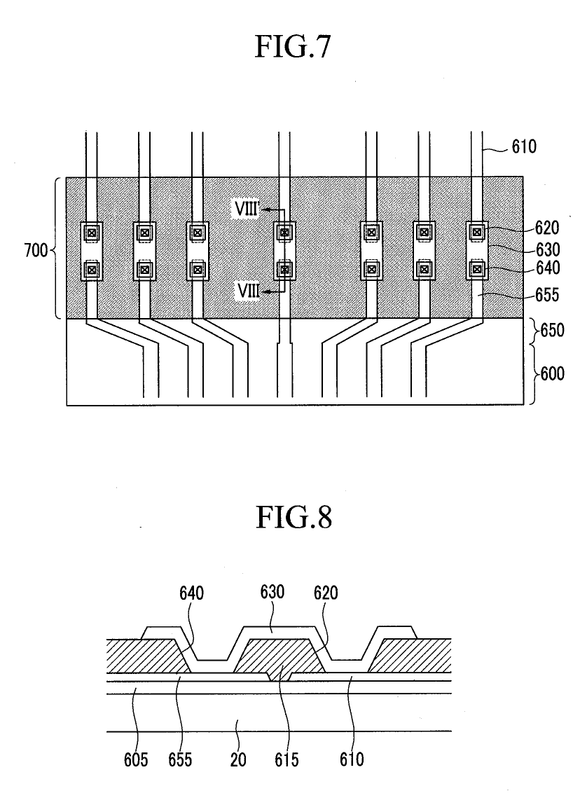

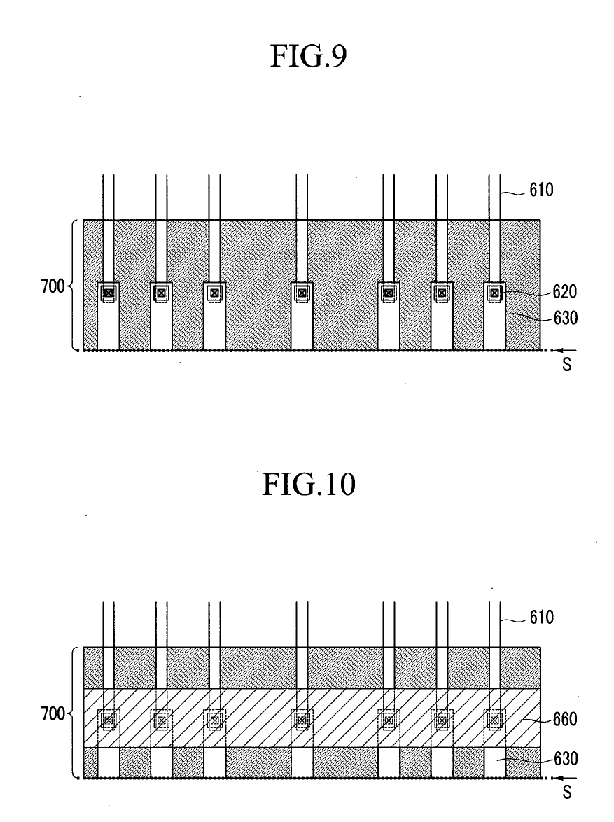

A structure for obtaining reliability of the products will now be described. FIG. 7 is a top plan, enlarged view of a B region of FIG. 6; FIG. 8 is a cross-sectional view taken along the line VIII-VIII′ of FIG. 7; FIG. 9 is a top plan view showing the cutting of a liquid crystal display; and FIG. 10 is a top plan view showing a liquid crystal display according to one or more embodiments of the present invention.

Referring to FIG. 7 through FIG. 9, an insulating layer 605 is formed on a substrate 20, and a data line 610 and a data line extension 655 are formed on the insulating layer 605. A passivation layer 615 is formed to cover the data line 610 and the data line extension 655. The passivation layer 615 has a first contact hole 620 exposing an end portion of the data line 610 and a second contact hole 640 exposing an end portion of the data line extension 655. The data line 610 may have a pad portion (not shown) having a wide width before the first contact hole 620.

A bridge 630 is formed to fill in the first contact hole 620 and the second contact hole 640 and connect the data line 610 and the data line extension 655. The bridge 630 may be made of the transparent conductive layer. For example, the bridge 630 may be made of ITO or IZO. The data line extension 655 includes the fan-out portion 650 that extends in the direction in which the interval between the data line extensions 655 becomes close(e.g., the interval gradually becomes narrower or the distance between the data line extensions 655 becomes short).

The scribing may be executed across the center of the bridge 630 disposed between the first contact hole 620 and the second contact hole 640. That is, the scribing may be executed according to a cutting line S shown in FIG. 9. If the liquid crystal display is cut, the data line 610 is not exposed on the end of the substrate 20, and the bridge 630 made of ITO or IZO is exposed. The ITO is not corroded compared with the different metal such that the reliability of the liquid crystal display may be increased.

Referring to FIG. 10, to prevent the generation of the corrosion due to moisture, the first contact hole 620 and the second contact hole 640 may be covered by a sealant 660.

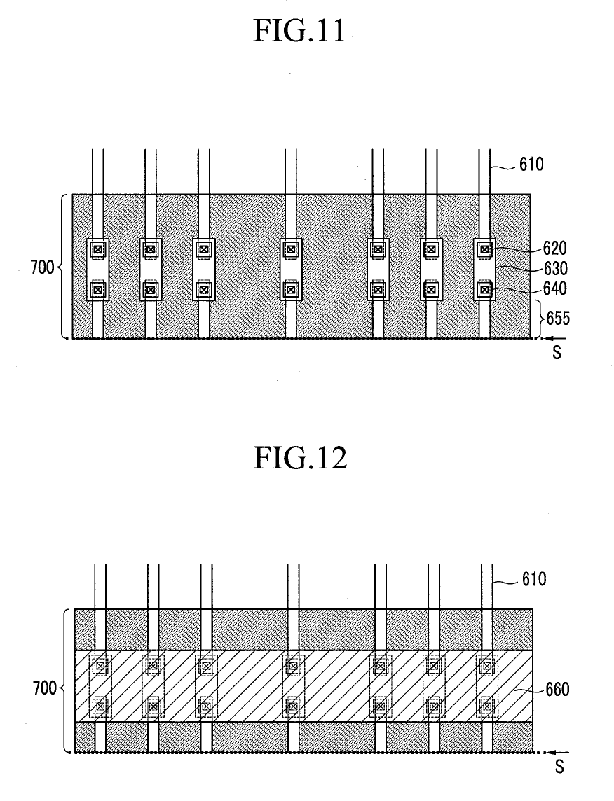

FIG. 11 is a top plan view showing the cutting of a liquid crystal display; and FIG. 12 is a top plan view of a liquid crystal display according to one or more embodiments of the present invention. Referring to FIG. 11 and FIG. 12, the cutting line is different from the embodiment described through FIG. 9 and FIG. 10 under the scribing process. A liquid crystal display according to an embodiment of the present invention may have a cutting line S across the data line extension 655. Accordingly, when the liquid crystal display is scribed according to the cutting line S, the cross-section of the data line extension 655 is exposed in the side direction of the substrate 20. However, the cross-section of the data line extension 655 shown in FIG. 6 is not connected to the display area 550, but is connected to the bridge 630 made of ITO or IZO. Accordingly, although corrosion may be generated on the end portion of the substrate 20, the corrosion may not progress to the display area 550 across the bridge 630 made of ITO or IZO. Also, to additionally prevent the generation of corrosion due to moisture, the first contact hole 620 and the second contact hole 640 may be covered by the sealant 660.

A method for manufacturing a liquid crystal display according to an embodiment of the present invention will now be described. FIG. 1 to FIG. 5 are referred to again. Gate lines 170 and data lines 200 defining display areas 400 are formed on a substrate 10. A passivation layer 215 is formed on the gate lines 170 or the data lines 200. The passivation layer 215 is pattered to form contact holes 220 exposing a pad portion 210 that is disposed on the end portions of the data lines 200.

A plurality of bridges 230 respectively connected to the data lines 200 in the contact holes 220 are formed. At least one of the plurality of bridges 230 is connected to a shorting bar 240. The shorting bar 240 may be simultaneously formed with the gate lines 170 or the data lines 200. The shorting bar 240 may be formed with the same layer as the gate lines 170 or the data lines 200. There may be a plurality of shorting bars 240. The first shorting bar among the plurality of shorting bars 240 may be connected to odd bridges such as the first bridge, the third bridge, and so on to the (2N-1)th bridge among a plurality of bridges 230. The second shorting bar among the plurality of shorting bars 240 may be connected to even bridges such as the second bridge, the fourth bridge, and so on to the (2N)th bridge among the plurality of bridges 230. The bridges 230 may be made of ITO or IZO. The bridges 230 may be simultaneously formed along with the pixel electrodes (not shown).

A test signal may be applied through the shorting bar 240 to detect defects of one or more of the data lines 200, the thin film transistors, and the pixel electrodes. The array test may be executed by using the shorting bar 240 in the COG structure, and the shorting bar 240 may be removed through the scribing process after the array test.

The static electricity prevention wiring line 205 may be formed near the pad portion 210 to prevent the generation of static electricity flowing from the shorting bar 240 in the formation step of the gate lines 170 and the data lines 200, and the static electricity prevention member 207 may be formed. The static electricity prevention member 207 may include a diode or a thin film transistor.

A sealant 250 to cover the contact hole 220 is coated on the edge of the substrate 10, and a liquid crystal is dripped. The sealant 250 is formed to cover a portion where the data lines 200 and the bridges 230 are connected to each other. Next, a provided upper panel is combined to the lower panel 10. The combined upper panel and lower panel 10 are scribed according to the cutting line S across the center of the bridge 230 in the scribing process. The liquid crystal display manufactured according to an embodiment of the present invention may be subjected to the array test in the COG structure, and corrosion due to moisture may be prevented.

A method for manufacturing the liquid crystal display according to another embodiment of the present invention will now be described with reference to FIG. 6 through FIG. 12.

Gate lines (not shown) and data lines 610 intersecting the gate lines are formed on a substrate 20, thereby defining display area 550. The data lines 610 may be extended. Thereby a fan-out portion 650 may be formed on the edge of the substrate 20 to be separated from the ends of the data lines 610. The fan-out portion 650 may be formed on the upper and lower portions of the substrate 20 by using one mask. A passivation layer 615 covering the data lines 610 is formed. The passivation layer 615 is patterned to form a first contact hole 620 exposing ends of the data lines 610 and a second contact hole 640 exposing ends of data line extensions 655.

A plurality of bridges 630 filling the first contact holes 620 and the second contact holes 640 and connecting the data lines 610 and the data line extensions 655 are formed. The bridges 630 may be formed of ITO or IZO. The bridges 630 may be simultaneously formed with the pixel electrodes.

A sealant 660 for combining the upper panel and the lower panel is formed on the edge of the substrate 20. To prevent corrosion due to moisture, the first contact holes 620 and the second contact holes 640 are formed to be covered by the sealant 660.

After combining the upper panel and the lower panel, the scribing process is executed. Again referring to FIG. 6, the scribing may be executed according to the first cutting line X to form a panel of a top bent type in which the data driver is formed on the upper portion of the panel. On the other hand, the scribing may be executed according to the second cutting line Y to form a panel of a bottom bent type in which the data driver is formed on the lower portion of the panel.

In one embodiment, the scribing is executed across the center of the bridges 630 between the first contact hole 620 and the second contact hole 640. That is, the scribing may be executed according to the cutting line S as shown in FIG. 9. If the liquid crystal display is scribed according to the cutting line S, the data line 610 is not exposed on the end of the substrate 20, but the bridge 630 made of ITO is exposed. The ITO does not generate corrosion, thereby increasing reliability.

In an alternative embodiment, the cutting line S may go across the data line extension 655. As shown in FIG. 11 and FIG. 12, if the scribing is executed according to the cutting line S, the data line extension 655 is exposed on the end of the substrate 20. However, the end of the data line extension 655 including the fan-out portion 650 shown in FIG. 6 is not connected to the display area 550, but is connected through the bridge 630 made of ITO. Accordingly, although corrosion is generated at the end of the substrate 20, the corrosion may not be transmitted to the display area 550 across the bridge 630 made of ITO.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a substrate;
a plurality of signal lines formed on the substrate;
a thin film transistor connected to the signal lines;
a pixel electrode connected to the thin film transistor;
an insulating layer covering the signal lines and having a first contact hole exposing a first end of the signal lines; and
a first bridge connected to the signal lines through the first contact hole,
wherein the first bridge is disposed on an edge of the substrate, and a cross-section of the first bridge is exposed in a side direction of the substrate.

2. The display device of claim 1, wherein the first bridge and the pixel electrode are formed with the same material.

3. The display device of claim 2, wherein the first bridge and the pixel electrode are made of a transparent conductive layer.

4. The display device of claim 3, wherein each of the signal lines comprises a pad portion of which a width is increased near the first contact hole.

5. The display device of claim 4, further comprising a static electricity prevention member formed on a circumference of the pad portion to prevent static electricity.

6. The display device of claim 1, wherein the signal lines comprises a gate line formed on the substrate and transmitting a gate signal.

7. The display device of claim 1, wherein the signal lines comprises a data line formed on the substrate and transmitting a data signal.

8. The display device of claim 1, further comprising:
a plurality of signal line extension portions formed on the substrate and separated from the signal lines;
a second contact hole exposing a second end of the signal lines and a third contact hole exposing the signal line extension portions, in the insulating layer; and
a second bridge connecting the signal lines and the signal line extension portions through the second contact hole and the third contact hole.

9. The display device of claim 8, wherein
the signal line extension portions include a fan-out portion that is curved in a direction in which a distance between the signal line extension portions becomes close.

10. A display device comprising:
a substrate;
a plurality of signal lines formed on the substrate;
a plurality of first signal line extension portions formed on the substrate and separated from the signal lines, the first signal line extension portions being disposed on an edge of the substrate;
a thin film transistor connected to the signal lines;
a pixel electrode connected to the thin film transistor;
an insulating layer covering the signal lines and the signal line extension portions, and including a first contact hole exposing a first end of the signal lines and a second contact hole exposing the first signal line extension portions; and
a first bridge connecting the signal lines and the signal line extension portions through the first contact hole and the second contact hole,
wherein a cross-section of the first signal line extension portions is exposed in a side direction of a cutting portion of the substrate.

11. The display device of claim 10, wherein the first bridge and the pixel electrode are made of the same material.

12. The display device of claim 11, wherein the first bridge and the pixel electrode are made of a transparent conductive layer.

13. The display device of claim 12, wherein the signal lines include a pad portion of which a width is increased near the first contact hole.

14. The display device of claim 10, wherein the signal lines include a gate line formed on the substrate and transmitting a gate signal.

15. The display device of claim 10, wherein the signal lines include a data line formed on the substrate and transmitting a data signal.

16. The display device of claim 10, further comprising:
a plurality of second signal line extension portions formed on the substrate and separated from the signal lines;
a third contact hole exposing a second end of the signal lines and a fourth contact hole exposing the second signal line extension portions, in the insulating layer; and
a second bridge connecting the signal lines and the second signal line extension portions through the third contact hole and the fourth contact hole.

17. The display device of claim 16, wherein the second signal line extension portions includes a fan-out portion that is curved in a direction in which an interval between the second signal line extension portions gradually becomes narrower.

18. A display device comprising:
a substrate;
a plurality of signal lines formed on the substrate;
a plurality of first signal line extension portions formed on the substrate and separated from the signal lines, the first signal line extension portions being disposed on an edge of the substrate;
a thin film transistor connected to the signal lines;
a pixel electrode connected to the thin film transistor;
an insulating layer covering the signal lines and the signal line extension portions, and including a first contact hole exposing a first end of the signal lines and a second contact hole exposing the first signal line extension portions; and
a first bridge connecting the signal lines and the signal line extension portions through the first contact hole and the second contact hole,
wherein a cross-section of the first signal lines extension is exposed in a side direction of a cut surface of the substrate, the bridge is formed in a light blocking region formed on a circumference of the pixel electrode, and a sealant is formed on the first contact hole and the second contact hole.

19. The display device of claim 18, wherein the first bridge and the pixel electrode are made of the same material.

20. The display device of claim 19, wherein the first bridge and the pixel electrode are made of a transparent conductive layer.

21. The display device of claim 20, wherein the signal lines comprise a pad portion of which a width is increased near the first contact hole.

22. The display device of claim 21, further comprising a static electricity prevention member formed on a circumference of the pad portion to prevent static electricity.

23. The display device of claim 20, wherein the substrate further comprises a driving circuit applying a signal to the pixel electrode.

24. The display device of claim 23, wherein the driving circuit is mounted on the substrate.

25. The display device of claim 18, further comprising:
a plurality of second signal line extension portions formed on the substrate and separated from the signal lines;
a third contact hole exposing a second end of the signal lines and a fourth contact hole exposing the second signal line extension portions, in the insulating layer; and
a second bridge connecting the signal lines and the second signal line extension portions through the third contact hole and the fourth contact hole.

26. The display device of claim 25, wherein the second signal line extension portions comprises a fan-out portion that is curved in a direction in which a distance between the second signal line extension portions becomes short.

27. A display device comprising:
a substrate;
a driving circuit electrically connected to the substrate;
a fan-out portion applying a signal to a pixel area from the driving circuit;
a light blocking portion formed between the fan-out portion and the pixel area;
a signal line connected to the fan-out portion;
a transistor connected to the signal line;
a pixel electrode connected to the transistor; and
a bridge overlapping the light blocking portion and connecting the fan-out portion and the signal line.

28. The display device of claim 27, wherein the driving circuit is mounted on the substrate.

29. The display device of claim 27, wherein a sealant is formed on the bridge.

30. The display device of claim 29, wherein the bridge is formed with the same material as the pixel electrode.

31. The display device of claim 30, further comprising a passivation layer having a contact hole exposing the signal line and the fan-out portion under the bridge.

32. The display device of claim 27, further comprising a signal line extension portion separated from the signal line on the light blocking portion of an edge of the substrate on an opposite side of the fan-out portion, and a second bridge connecting the signal line and the signal line extension.

33. The display device of claim 32, further comprising a passivation layer having a contact hole exposing the signal line and the fan-out portion under the bridge.

34. The display device of claim 33, wherein a sealant is formed on the contact hole.

35. A method for manufacturing a display device, the method comprising:
forming a signal line on a first substrate;
forming a passivation layer on the signal line, the passivation layer including a contact hole exposing a portion of the signal line;
forming a bridge on the contact hole; and
coating a sealant on the contact hole.

36. The method of claim 35, wherein the bridge is made of indium tin oxide (ITO) or indium zinc oxide (IZO).

37. The method of claim 36, further comprising: before coating the sealant on the contact hole, forming a second substrate corresponding to the first substrate, wherein the second substrate has a light blocking portion formed in a region corresponding to the bridge.

38. A method for manufacturing a display device, the method comprising:
forming a signal line on a first substrate;
forming a signal line extension separated from the signal line;
forming a passivation layer on the signal line, the passivation layer exposing a portion of the signal line and having a contact hole exposing a portion of the signal line extension;
forming a bridge on the contact hole, the bridge connecting the signal line and the signal line extension; and
coating a sealant on the contact hole.

39. The method of claim 38, wherein the bridge is formed of a transparent conductive layer.

40. The method of claim 39, further comprising: before coating the sealant on the contact hole, forming a second substrate corresponding to the first substrate, wherein the second substrate has a light blocking portion formed on a region corresponding to the bridge.
